(19) United States
(12) Patent Application Publication
(10) Pub. No.: US 2007/0170657 A1
(43) Pub. Date: Jul. 26, 2007

(54) Stuffing box bushing, assembly and method of manufacture

(76) Inventor: Mark R. Wilkinson, Huntington, MA (US)

Correspondence Address: GREENBERG TRAURIG, LLP, MET LIFE BUILDING, 200 PARK AVENUE, NEW YORK, NY, 10166, US

(21) Appl. No.: 11/336,143

(22) Filed: Jan. 20, 2006

(51) Int. Cl. F16J 15/00

(52) U.S. Cl. 277/585

(57) ABSTRACT

A one-piece bushing to be inserted into the seal cavity of a rotary mechanical device includes a one-piece cylindrical bushing element with a single slit to allow easy installation over the shaft. The bushing is a substantially cylindrical semi-rigid member with an inner bore closely approximating the outer diameter of the shaft and includes a groove at the motor end on the outer surface and a corresponding groove on the inner surface to provide a lantern ring. Milling slots or other types of relief are formed on one surface of a flat piece of material to allow for shaping into cylindrical form and to provide for easy installation over an installed device shaft. Seal water openings are provided between the outer groove and inner groove of the bushing to form a lantern ring. Generally, two or three packing rings are added on the motor side to complete the shaft sealing system for installation in the seal cavity.

### BACKGROUND OF THE INVENTION

This invention relates to an improved sealing system for a stuffing box of a rotary mechanical device, and more particularly to a one-piece shaft sealing bushing to be placed about a mounted shaft in a seal cavity or stuffing box of the mechanical device, and a method for fabricating and installing the one-piece bushing.

Rotary mechanical devices, such as mixers and centrifugal pumps include an impeller mounted on a shaft which is driven by an electrical motor. The shaft passes through a seal cavity or a stuffing box defined by a cylindrical cavity in the device housing. Typically, the shaft is supported by bearings at the motor end and seals are placed in the stuffing box to engage the shaft to prevent fluid from passing through the seal cavity and reaching the bearing and the motor to avoid causing damage to both.

In order to eliminate the need to disassemble the equipment to allow insertion of a solid bearing or bushing over the shaft, stuffing box bearings and bushings are usually molded or machined in two halves. This allows for easier installation, but requires mechanical registration of both halves. This is usually done with steel pins prior to insertion so that both halves will be installed and sealed together in the bottom of the stuffing box. In mechanical pumps, the seal cavity passes chemical fluids, solids or solvents being pumped, many of which are corrosive or erosive. Accordingly, it is important that appropriate packing material is placed within the seal cavity. Seal water is pumped into the seal cavity through a flush port to prevent the fluid being pumped or mixed from traveling along the shaft to the bearings and motor and to provide lubricant to the packing. Over extended use, the pump shaft may develop a whip as the bearing or bushing wears. Thus, it is highly desirable to provide a sealing system with a non-compressive member that provides an effective seal to reduce the amount of pumped fluid from entering the seal cavity.

A suitable stuffing box sealing system is shown in U.S. Pat. No. 6,834,862 issued to the applicant herein, the contents of which are incorporated by reference. This patent describes a seal system with a bearing surface. This shaft sealing system works well particularly when an additional bearing surface is required.

While there are a wide variety of devices available for providing seals in rotary devices, it is desirable to provide a improved sealing system for the impeller end of the shaft and allow a reduction in fluid entering the seal cavity that can be easily installed.

### SUMMARY OF THE INVENTION

Generally speaking, in accordance with the invention, a one-piece semi-rigid bushing to be positioned over a shaft in the seal cavity of a rotary mechanical device and moved to the impeller end is provided. The bushing is formed with a lantern ring at the motor end. The one-piece bushing is formed from a substantially planar piece of suitable material with milling slots or other types of relief formed on one surface and shaped into a cylinder and restrained to provide easy installation over an installed device shaft.

The semi-rigid bushing is manufactured of a non-ferrous metal, thermoplastic polymer, filled thermoplastic material, or other man-made non-compressible material for providing an improved seal and resistance to industrial solutions. The inner bore of the one-piece bushing closely approximates the outer diameter of the pump shaft and the outer wall forms a cylinder approximating the diameter of the stuffing box.

The bushing is manufactured by cutting a plurality of milling slots in a sheet of bushing material of appropriate thickness to fill the stuffing box annulus. The sheet is cut to a length corresponding to the diameter of the stuffing box annulus. The milled piece is then formed into a cylinder, restrained and heated and coined to form the one piece bushing with a single slit with the milling slots on the side of the bushing facing the pump shaft.

The motor end of the bushing may include an internal groove and a corresponding outer groove with seal water openings to provide a lantern ring on the motor side of the bushing. Generally, two or three packing rings are added on the motor side of the bushing to complete the assembly. An O-ring groove may be formed on the outer surface for improved isolation of pumped product within the cavity.

Accordingly, it is an object of the invention to provide an improved shaft sealing system to be inserted into a seal cavity of a rotary mechanical device.

Another object of the invention is to provide an improved shaft sealing system for a rotary mechanical device including a one piece semi-rigid bushing member to surround the impeller end of the device shaft.

A further object of the invention is to provide an improved shaft sealing system for a rotary mechanical device including a semi-rigid bushing member having an integral lantern ring grove for controlling the amount of seal water entering the seal cavity.

Another object of the invention is to provide an improved shaft sealing system for a rotary mechanical device including a one piece semi-rigid bushing member having a plurality of milling slots or other types of relief on the inner bore to allow for shaping in cylindrical form with the milled side facing the rotary shaft.

Yet another object of the invention is to provide an improved shaft sealing system for a rotary mechanical device including a one piece semi-rigid bushing member having a single slit to allow for easy installation about an installed shaft.

Yet a further object of the invention is to provide a method of manufacture of an improved semi-rigid bushing member particularly well adapted for installation about a mounted motor shaft.

Still another object of the invention is to provide an improved sealing system for a rotary mechanical device having an outer O-ring for improved isolation of the product being handled and seal water in the seal cavity.

Yet another object of the invention is an improved semi-rigid seal bushing for use with complementary flexible packing rings for use in a shaft sealing system to be inserted into the seal cavity of rotary mechanical devices.

Still other objects and advantages of the invention will in part be obvious and will in part be apparent from the specification.

The invention comprises a product possessing the features, properties, and the relation of components which will be exemplified in the product hereinafter described and the scope of the invention will be indicated in the claims.

### BRIEF DESCRIPTION OF THE DRAWINGS

For a fuller understanding of the invention, reference is had to the following description taken in connection with the accompanying drawings, in which:

FIG. 1 is a partial cross-sectional view of a typical rotary fluid pump requiring a seal system in the seal cavity;

FIG. 2 is an enlarged cross-sectional view of the seal cavity of the pump of FIG. 1 showing a shaft sealing system in accordance with the invention in place in the seal cavity;

FIG. 3 is a side elevational view of the bushing element of the shaft sealing system of FIG. 2 prepared in accordance with the invention;

FIG. 4 is a sectional view of the bushing element of FIGS. 2 and 3 taken along line 4-4 of FIG. 3;

FIG. 5 is a perspective view of a block of milled rectangular preform from which the bushing element of FIG. 2 is cut from;

FIG. 6 is a perspective view of the bushing element formed with a longitudinal split in accordance with one embodiment of the invention;

FIGS. 7 and 8 are two side elevational views of the bushing element showing a diagonal and a multiple cut slit, respectively, in accordance with additional embodiments of the invention; and

FIG. 9 is a side elevational view in cross-section of an embodiment of the invention with an outer O-ring installed in the bushing element of the shaft sealing system of FIG. 2.

### DESCRIPTION OF THE PREFERRED EMBODIMENTS

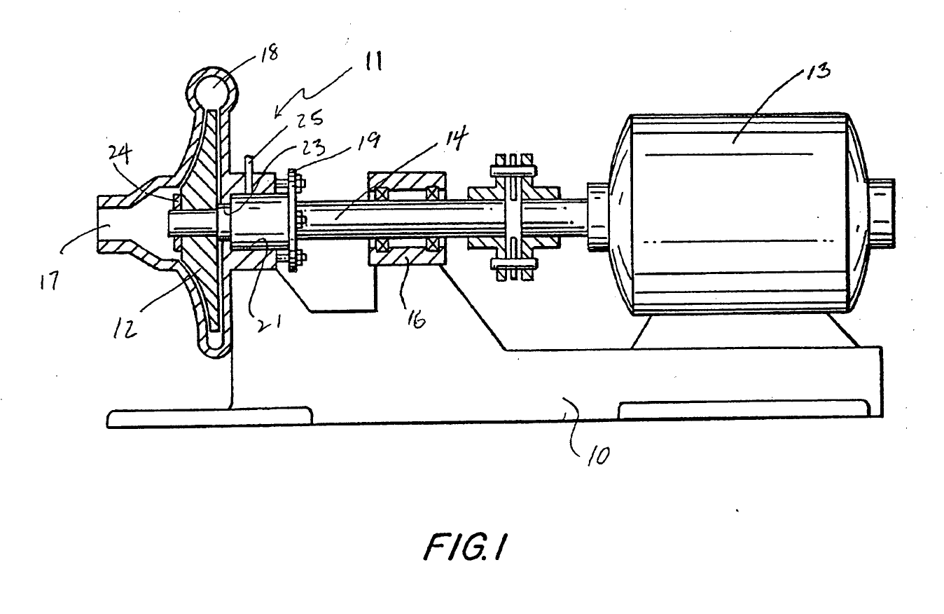

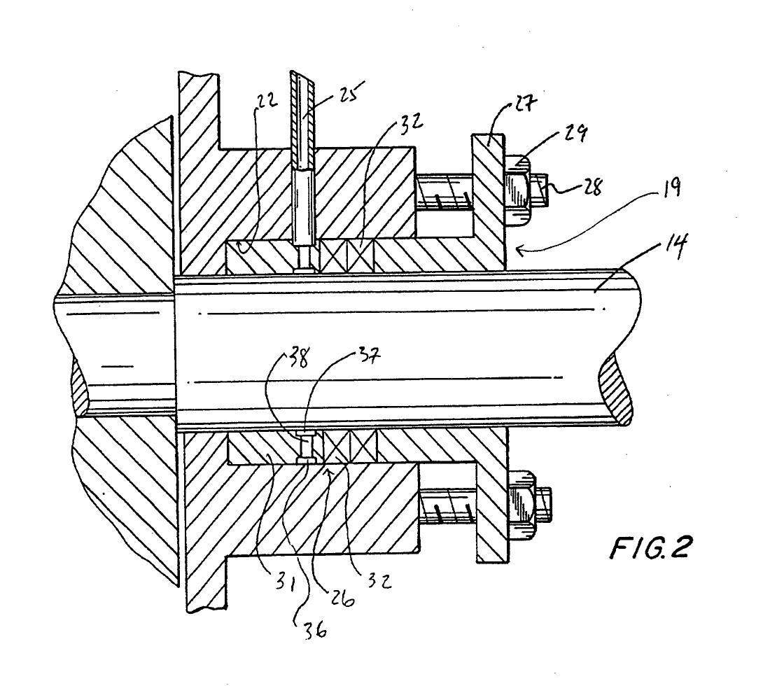

FIG. 1 illustrates a generic form of a centrifugal pump 11 in cross-section mounted on a frame 10. Pump 11 includes a centrifugal impeller 12 driven by an electric motor 13 that drives a rotary shaft 14 coupled to impeller 12. Shaft 14 is supported by a bearing housing 16 and rotates to draw fluid in through an impeller inlet 17 and expel the fluid out through a radial impeller outlet 18. Pump 11 includes a housing 19 having an internal bore 21 that defines a seal cavity or stuffing box 22 with shaft 14 passing therethrough as shown in detail in FIG. 2. Housing 19 includes an opening 23 through which shaft 14 passes to engage impeller 12 and also includes a flush port 25 for introduction of seal water into seal cavity 22. Shaft 14 is coupled to impeller 12 by a nut or fastener 24 at the end portion of shaft 14 projecting through impeller 12.

Pump 11 operates by drawing a fluid to be pumped into inlet 17 and forced to exit at outlet 18. During pumping, fluid tends to migrate and be forced into seal cavity 22 through opening 23. A wide variety of seals and venting configurations are available to be placed in seal cavity 22 abutting opening 23 in order to restrict and limit entry of pumped fluid into seal cavity 22. If fluid enters seal cavity 22 and migrates to bearings at the motor end, the bearings may be subject to substantial degradation due to the corrosive action of the pumped fluid.

FIG. 2 is an enlarged view of seal cavity 22 with a bushing seal element 31 and shaft sealing assembly 26 in accordance with the invention in place. The motor end of seal cavity 22 is defined by a gland follower 27 mounted on gland bolts 28 and secured in place by gland nuts 29.

As shown in FIG. 2, shaft sealing assembly 26 installed in seal cavity 22 includes bushing seal element 31 positioned against the impeller end of seal cavity 22. A pair of compressible sealing rings 32 are positioned on the motor side of seal element 31. These elements are secured within seal cavity 22 by gland follower 27. Various types of packing rings suitable for us are shown in U.S. Pat. No. 5,370,926, No. 4,559,862, No. 4,431,698, No. 4,371,180 and No. 4,298,207, the contents of which are incorporated herein by reference.

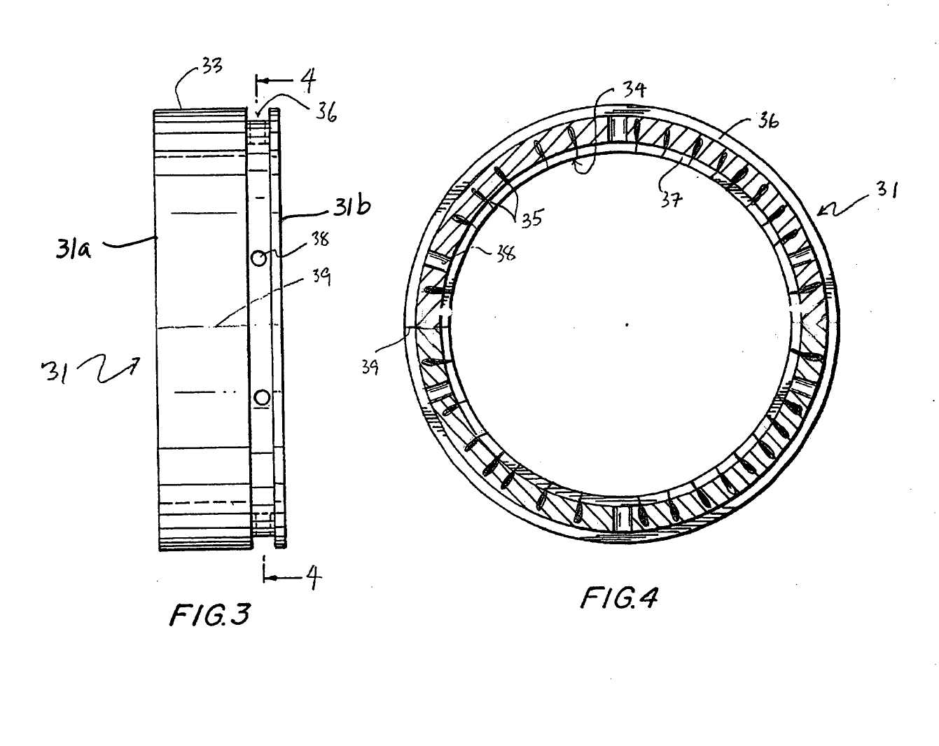

FIG. 3 illustrates bushing seal element 31 in a side elevational view. Bushing seal 31 is custom made for a particular shaft and pump. A cross-sectional elevational view of bushing seal element 31 is shown in cross-section in FIG. 4.

Bushing seal element 31 is a substantially cylindrical semi-rigid member with an outer surface 33 dimensioned to be slightly smaller than and fit within an internal bore 21 of pump housing 19. The dimension of inner bore 34 of bushing 31 is slightly larger than the outer dimension of pump shaft 14. Bushing seal element 31 has a top end 31a at the impeller end and a bottom end 31b at the gland end. Outer surface 33 of bushing seal element 31 is formed with an outer seal water groove 36 at the gland end thereof. Inner bore 34 of seal element 31 provides an additional bearing surface for shaft 14 when in position as shown in FIG. 2, and this is custom dimensioned for a particular mechanical device. Preferably, bushing seal element 31 fills up the space along inner bore 34 and shaft 14 from the outside of the lantern ring groove to the bottom of the stuffing box shoulder.

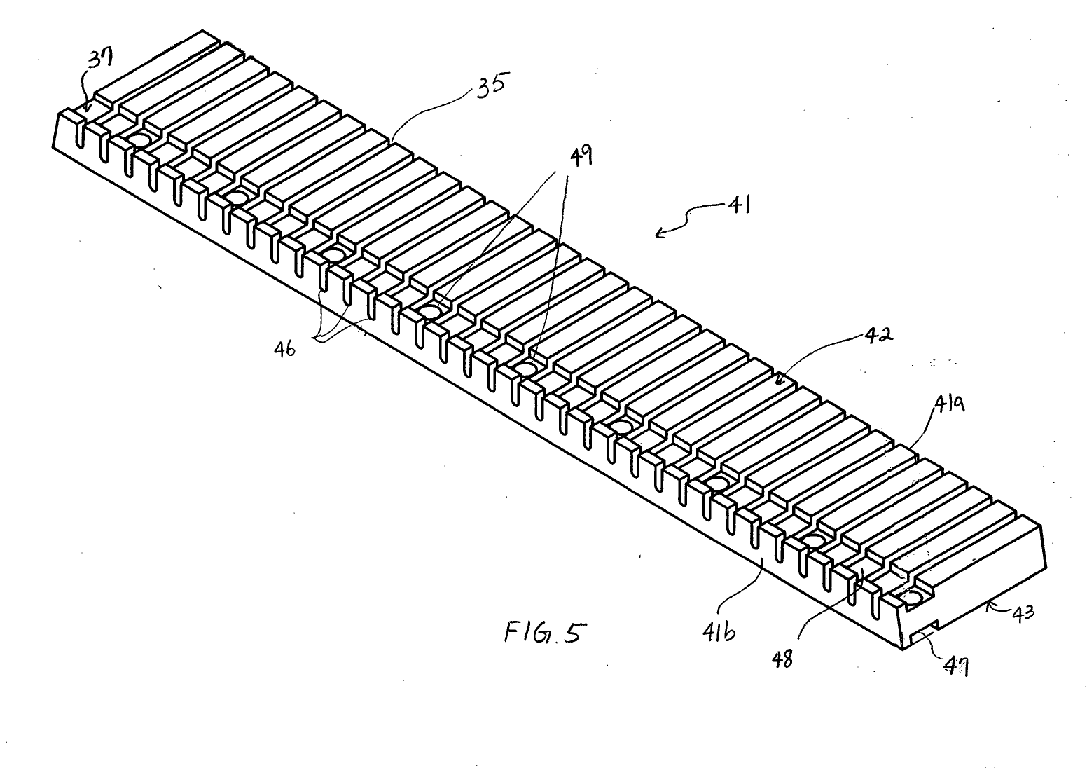

Bushing element 31 is formed from a flat rectangular piece of material 41 having an upper surface 42 and a lower surface 43 as shown in FIG. 5. Piece 41 has a top side 41a that will face the impeller and a bottom side 41b that will face the motor end and two short edges between. A plurality of milling slots 46 or other types of relief are cut into upper surface 42 of rectangular piece 41 so that it may easily be deformed to a cylindrical form consistent with the shape of pump shaft 14. Milling slots 46 extend from top side 41a to bottom side 41b as shown in FIG. 5 and when formed into a cylinder surrounding the periphery of rotary shaft 14. Preferably, the depth of milling slots 46 should be between about 60% to about 85% of the thickness of bushing element 41. The width of slot 42 is between about 0.080″ to about 0.105.″ In a preferred embodiment, slot 42 is about 0.093″ thick. A lantern groove or outer seal water groove 47 is formed on uncut surface 43 of piece 41. Typically, the width of lantern ring groove 47 will become wider as the thickness of the stock and the shaft diameter increases.

An inner seal water groove 48 is formed in bushing seal element 31 at a position corresponding to the location of outer seal water groove 47 to create a lantern ring at the gland end of bushing 31. A plurality of seal water holes 49 are formed between outer seal water groove 47 and inner seal water groove 48. Bushing seal element 31 is fabricated so that outer surface 33 at the impeller end is longer than the width of outer seal water groove 47 as shown in FIG. 3. Outer seal water groove 47 is dimensioned to align with flush port 25 formed in housing 19.

Bushing seal element 31 is semi-rigid and formed of materials which will not be attacked or destroyed by corrosive fluids being transported by pump 11. The material of construction includes a wide variety of material. These include non-ferrous metals, silica-based materials, carbonaceous materials, polymeric materials, such as nylon, polyacetals, polyvinylchloride, polyethylene, polypropylene and fluorine containing polymers, such as (polytetrafluoroethylene (PTFE), perfluoroalkoxy (PFA), or other suitable plastic material). The polymeric materials may be filled or unfilled. Filled materials may include a molybdenum/carbon or glass filled thermoplastic material, such as a PTFE, PFA and nylon.

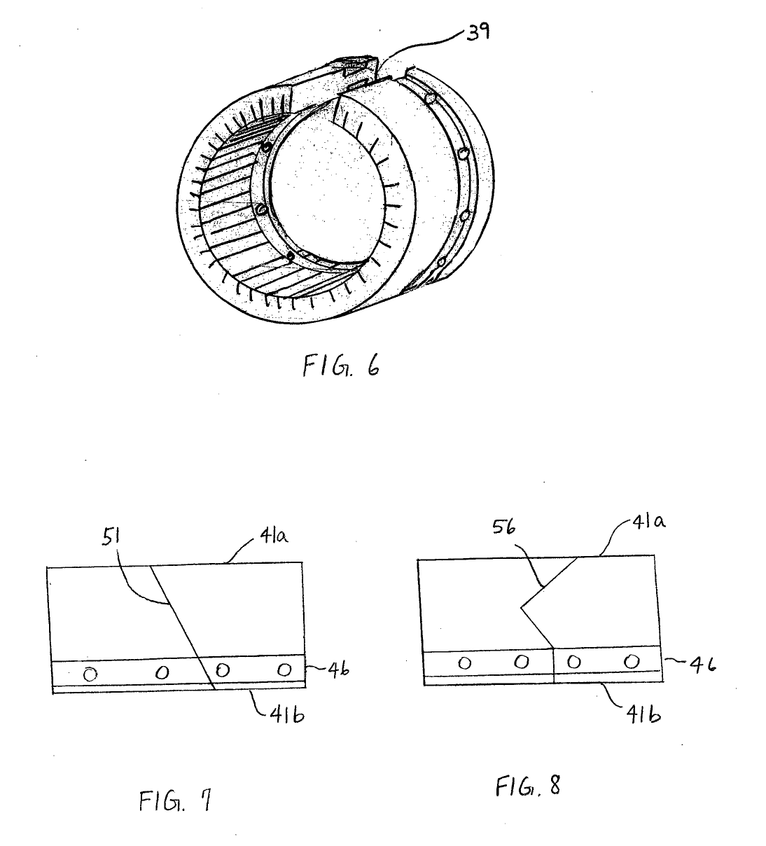

In order to be able to place bushing seal element 31 in position in seal cavity 22, bushing seal element 31 is formed by deforming milled piece 41 into a cylinder and restrained in position. Thus, it will have only a single slit 39. A single slit allows bushing seal element 31 to be pried apart and placed around installed shaft 14 and pushed into position at the impeller end of seal cavity 22. Slit 39 may be substantially axial and parallel to shaft 14 or vary in any degree up to but not including 90 degrees depending on the specific application. FIG. 6 shows an axial slit 39. FIG. 7 shows an inclined slit 51 for bushing seal element 31 and FIG. 8 shows a compound slit 56. Generally, at least one or two packing rings 61 are positioned on the gland side of seal element 31 when installed.

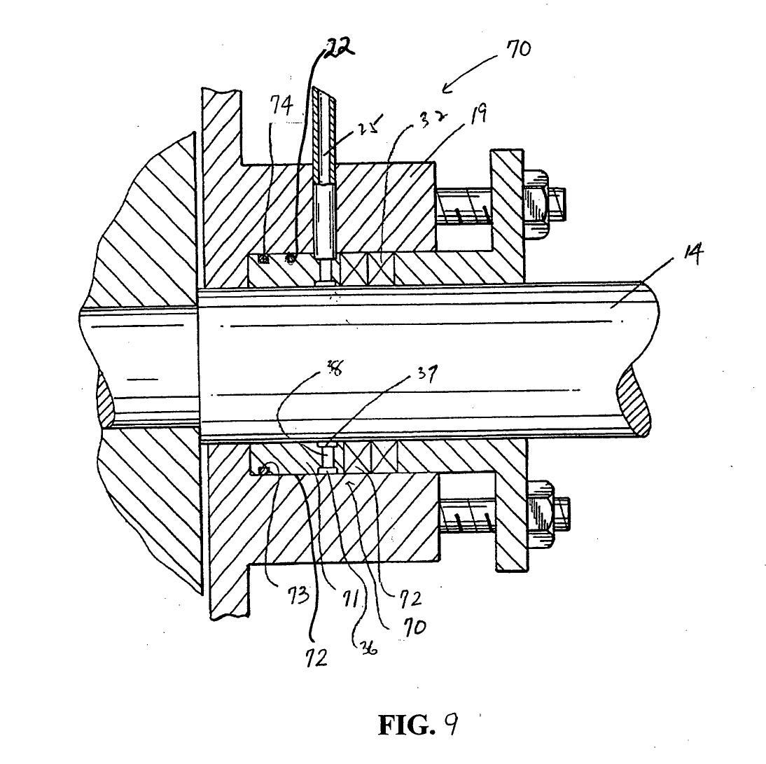

FIG. 9 illustrates an embodiment of the invention wherein a modified shaft sealing system 70 with a bushing seal element 71 includes an outer surface 72 with an O-ring 74 groove positioned in seal cavity 22. An O-ring 74 is positioned in an O-ring groove 73 formed on outer surface 72 of bushing seal 71. O-ring 74 can be formed of a variety of resilient materials, including perfluoroelastomers or silicone rubbers and the like, or other resilient material compatible with the pumped fluid for providing an additional barrier to isolate the motor end of shaft 14 from fluid entering seal cavity 22. O-ring 74 provides an additional obstacle to prevent fluid from entering seal cavity.

In another embodiment, outer surface 72 of bushing seal element 71 may also contain milled slots to help assist in properly centering the one-piece shaft sealing bushing assembly if the application bore is elliptical in shape rather than cylindrical in shape. Also, inner bore 34 may be fitted with contact devices such as O-rings or hydraulic seals that would provide directional dams against materials entering the stuffing box area.

Bushing seal elements in accordance with the invention, a milled sheet of bushing seal element with or without the lantern ring groove may be milled for a standard size shaft. Once a particular shaft is measured for its diameter, the milled sheet may be cut to the correct size to fit with the cavity annulus about the shaft. For example, a milled sheet made of PTFE is first cut to the dimension needed and is then coined by restraining the cut milled sheet in a steel form. The milled sheet is also wrapped around a inner metallic sleeve to form a cylinder. The coined milled sheet in then heated for about one hour at 350° F. The temperature time of the heat varies depending on the material and the thickness of the material.

### EXAMPLE 1

The dimensions of a typical bushing seal element 31 made of filled PTFE where the shaft is 3″ in diameter is as follows:

(1) Width of each of the milling slots are 0.093″;

(2) Length of the lantern ring groove is 0.375″;

(3) Depth of the lantern ring groove is 0.1″;

(4) Length of the bushing element between each milling slot is ⅛″; and

(5) Length of the bushing element from the top to the bushing to the lantern ring is 1.5″.

It can readily be seen that the bushing including a cylindrical seal and seal system constructed in accordance with the invention can be easily installed in a conventional rotary impeller pump without the need to use pins necessary to guarantee alignment due to the one-piece bushing construction of the seal upon installation. Generally only two packing rings are added to complete installation. When in place, the seal will temporarily support the impeller end of the pump shaft, providing an additional bearing surface to aid in eliminating the whip commonly found in pump shafts. Since the clearance between the pump shaft and the bushing is relatively small, seal water entering the lantern ring groove would be considerably throttled, thereby minimizing the quantity of seal water flushing and lubricating the bearing and finally entering into and diluting the product being pumped.

Due to the close clearances available, improved support of the impeller is assured, resulting in longer life of the main bearings and packing materials as well as reduced wear of the throat of the rotary device. Minimum seal water is required with less product contamination because of this throttling effect. Minimum external leakage also results from the installation of the sealing system constructed and arranged in accordance with the invention.

It will thus be seen that the object set forth above, among those made apparent from the preceding description are efficiently attained and, since certain changes may be made in the device set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention, which, as a matter of language, may be said to fall there between.

What is claimed is:

1. A one piece shaft sealing bushing for use in a seal cavity of a rotary mechanical device including a rotating shaft coupled to a motor, comprising:
a semi-rigid one piece cylindrical body with a slit dimensioned to fit into the seal cavity over the shaft at one end of the seal cavity;
wherein the cylindrical body is formed with a plurality of milling slots on the side facing the rotating shaft to permit opening the slit to permit installation about an installed shaft.

2. The bushing of claim 1, wherein the body is formed of a non-ferrous metal material.

3. The bushing of claim 1, wherein the body is formed from a thermoplastic material.

4. The bushing of claim 1, wherein the thermoplastic material is filled.

5. The bushing of claim 1, wherein the body is formed from a polytetrafluoroethylene material.

6. The bushing of claim 1, wherein the body is formed from a perfluoroalkoxy material.

7. The shaft sealing system of claim 1, wherein the cylindrical body has a cylindrical outer wall formed with a groove at the motor end and an internal groove in the inner bore at the location of the outer groove to form an integral lantern ring with at least one hole connecting the inner groove and outer groove for passage of seal water.

8. The bushing of claim 1, wherein the width of the outer groove at the motor end is narrower than the length of cylindrical outer wall at the opposite end.

9. The bushing of claim 1, wherein corresponding alignment holes are formed in each side of the slit seal and alignment pins are positioned in the alignment holes.

10. The bushing of claim 1, wherein the outer surface of cylindrical body includes a groove with an O-ring disposed therein.

11. The bushing of claim 1, further including at least one compressible packing ring disposed on the motor side of the semi-rigid body in the seal cavity.

12. The bushing of claim 1, wherein the rotary device is a rotary pump with an impeller.

13. The bushing of claim 1, wherein the cylindrical body has a plurality of milling slots on the outer surface of the semi-rigid cylindrical body.

14. A method of preparation of shaft sealing bushing for use in an annular shaped seal cavity of a rotary mechanical device with a rotating shaft coupled to a motor, comprising:
providing a semi-rigid one-piece flat sheet of desired thickness having a first surface to be milled and an opposed second surface;
milling a plurality of slots in the first surface;
cutting the flat sheet in a length to form a cylinder of desired diameter;
shaping the cut sheet into a cylindrical shaped body with the plurality of milling slots in the first surface facing the inside of the cylinder; and
restraining and heating the cylindrical bushing in the cylindrical form.

15. The method of claim 14, including the step of forming a groove at the motor end and an internal groove in the opposed milled surface at the location of the outer groove to form an integral lantern ring with at least one hole connecting the inner groove and outer groove for passage of seal water when the body is formed into a cylinder.

16. The method of installing a one-piece bushing in the seal cavity of a rotary mechanical device, comprising:
providing a one-piece bushing dimensioned to fit within the annulus of the seal cavity having a plurality of milling slots on the inside surface;
opening the bushing at the slit; and
positioning the bushing about the shaft in the seal cavity.

17. The method of claim 16, further including installing flexible packing ring about the shaft at the motor end of the seal cavity.
